(19) United States
(12) Patent Application Publication
(10) Pub. No.: US 2021/0287041 A1
(43) Pub. Date: Sep. 16, 2021

(54) Processing Device, Processing Method, Computer Program, And Processing System

(71) Applicant: AXELL CORPORATION, Tokyo (JP)

(72) Inventor: Shuji OKUNO, Nara (JP)

(73) Assignee: AXELL CORPORATION, Tokyo (JP)

(21) Appl. No.: 17/301,455

(22) Filed: Apr. 2, 2021

Related U.S. Application Data
(63) Continuation of application No. 17/251,141.

(30) Foreign Application Priority Data
Mar. 6, 2018 (JP) 2018-039896

(51) Int. Cl. G06K 9/62; G06K 9/40; G06N 3/04; G06N 3/08

(52) U.S. Cl. CPC G06K 9/6256; G06K 9/6298; G06N 3/08; G06N 3/04; G06K 9/40

(57) ABSTRACT

To provide a processing device, a processing method, a computer program, and a processing system that improve efficiency of an arithmetic processing by using a convolutional neural network (CNN). The processing device inputs data to a convolutional neural network including a convolutional layer and acquires an output from the convolutional neural network. The processing device includes a first converter that performs non-linear space conversion on data to be input to the convolutional neural network, and/or a second converter that performs non-linear space conversion on data output from the convolutional neural network.

### RELATED APPLICATIONS

This application is a continuation-in-part of and claims priority to U.S. patent application Ser. No. 17/251,141 filed Dec. 10, 2020 entitled Processing Device, Processing Method, Computer Program, And Processing System, which is the U.S. National Phase of and claims priority to International Patent Application No. PCT/JP2019/008653, International Filing Date Mar. 5, 2019, entitled Processing Device, Processing Method, Computer Program, And Processing System, which claims priority to Japanese Patent Application No. 2018-039896 filed Mar. 6, 2018, all of which are hereby incorporated herein by reference in their entireties.

### FIELD

The present invention relates to a processing device, a processing method, a computer program, and a processing system that improve the efficiency of processing using a convolutional neural network.

### BACKGROUND

Deep learning using a neural network has been applied to many fields. Particularly, in the fields of image recognition and speech recognition, deep learning that uses a neural network in a multi-layer structure is exhibiting high recognition accuracy. In the multi-layered deep learning, image recognition using a convolutional neural network that uses a convolutional layer that extracts an input feature and a pooling layer plural times (hereinafter, CNN (Convolutional Neural Network)) has been performed.

In the learning using the CNN, since the neural network is multi-layered and used, an amount of used memory increases, and a long period of time is required until a learning result is output. Therefore, pre-processing such as normalization of a luminance value (a pixel value) is being performed before image data, which becomes a target of recognition processing, is input to the CNN (Patent Literature 1 and the like).

### CITATION LIST

### Patent Literature

Patent Literature 1: Japanese Patent Application Laid-open No. 2018-018350

### SUMMARY

### Technical Problem

A certain effect can be acquired even by the processing such as normalization. However, a method that can acquire a CNN processing result at a higher speed without being affected by an output result has been expected.

The present invention has been achieved in view of the above problems, and an object of the present invention is to provide a processing device, a processing method, a computer program, and a processing system that improve the efficiency of arithmetic processing by a CNN.

### Solution to Problem

A processing device according to the present invention is a processing device that inputs data to a convolutional neural network including a convolutional layer and acquires an output from the convolutional neural network, and includes a first converter that performs non-linear space conversion on data to be input to the convolutional neural network, and/or a second converter that performs non-linear space conversion on data to be output from the convolutional neural network.

In the processing device according to the present invention, the first and second converters include an input layer having the number of nodes same as the number of channels of the data to be input to the convolutional neural network or the number of output channels, a second layer being a convolutional layer or a dense layer having a larger number of nodes than the input layer, and a third layer being a convolutional layer or a dense layer having a smaller number of nodes than the second layer.

In the processing device according to the present invention, the first converter stores therein a parameter in the first converter learned based on a difference between first output data to be acquired by inputting data acquired by converting learning data by the first converter to the convolutional neural network, and second output data corresponding to the learning data.

In the processing device according to the present invention, the second converter stores therein a parameter in the second converter learned based on a difference between third output data acquired by converting data acquired by converting learning data by the first converter, or output data acquired by inputting the learning data to the convolutional neural network without performing conversion by the first converter, by the second converter, and fourth output data corresponding to the learning data.

The processing device according to the present invention includes a band pass filter that decomposes data to be output from the convolutional neural network according to a frequency, and a learning executing unit that learns parameters in the first converter and the convolutional neural network based on a difference between fifth output data acquired by inputting first output data, which is acquired by converting learning data by the first converter and inputting the converted data to the convolutional neural network, to the band pass filter, and sixth output data acquired by inputting second output data corresponding to the learning data to the band pass filter.

The processing device according to the present invention includes a band pass filter that decomposes data to be input to the first converter according to a frequency, and a learning executing unit that learns parameters in the first converter and the convolutional neural network based on a difference between seventh output data acquired by inputting data, which is acquired by inputting learning data to the band pass filter and is converted by the first converter, to the convolutional neural network, and eighth output data corresponding to the learning data.

In the processing device according to the present invention, the data is image data configured by values of pixels arranged in a matrix.

The processing method according to the present invention is a processing method of inputting data to a convolutional neural network including a convolutional layer and acquiring an output from the convolutional neural network, wherein non-linear space conversion is performed on data to be input to the convolutional neural network, and data after space conversion is input to the convolutional neural network.

In the processing method according to the present invention, the space conversion is performed by using a space conversion parameter learned based on a difference between first output data acquired by inputting data obtained by performing the space conversion on learning data to the convolutional neural network, and second output data corresponding to the learning data.

The processing method according to the present invention is a processing method of inputting data to a convolutional neural network including a convolutional layer and acquiring an output from the convolutional neural network, wherein data to be output from the convolutional neural network is acquired, and non-linear space conversion is performed on the acquired data, which is then output.

A computer program according to the present invention causes a computer to execute a process of receiving data to be input to a convolutional neural network including a convolutional layer, a process of performing non-linear space conversion on the data, and a process of learning parameters in space conversion and the convolutional neural network based on a difference between first output data acquired by inputting data obtained by performing space conversion on learning data to the convolutional neural network, and second output data corresponding to the learning data.

The computer program according to the present invention causes a computer to execute a process of performing non-linear space conversion on data to be output from a convolutional neural network including a convolutional layer, and a process of learning parameters in the convolutional neural network and space conversion based on a difference between third output data acquired by inputting learning data to the convolutional neural network and performing space conversion on the data, and fourth output data corresponding to the learning data.

The processing system according to the present invention includes a use device that transmits input data to any one of the processing devices described above or a computer that executes any one of the computer programs described above and receives data output from the processing device or the computer to use the received data.

In the processing system according to the present invention, the use device is a television receiver, a display device, an imaging device, or an information processing device including a display unit and a communication unit.

According to one aspect of the present invention, the first converter performs a process of distorting input data non-linearly with respect to an input and an output and then the input data is input to the convolutional neural network. Space conversion to emphasize a feature is learned by performing non-linear space conversion on data and inputting the data to the convolutional layer to perform learning.

According to one aspect of the present invention, the converter has nodes of the same number as that of input channels in a first layer, and a convolutional layer having a larger number of nodes than the number of input channels in a second layer. The converter further has a third layer in which an output is performed by nodes of a smaller number than the number of nodes in the second layer. A converter that realizes non-linear space conversion processing corresponding to a learning object is provided by learning using the convolutional neural network.

According to one aspect of the present invention, a second converter that performs inverse conversion of the non-linear space conversion performed by the first converter or different non-linear conversion separately is used in a subsequent stage of the convolutional neural network. There may be a case in which conversion to restore the non-linear space conversion performed on the input side is required on the output side, for example, when input data and output data are image data. The second converter also configures a part of the neural network having three layers, in which a second layer has a larger number of nodes than that in other layers, as in the converter on the input side, to perform learning together. Both or either one of the first converter and the second converter is used.

According to one aspect of the present invention, a band pass filter is provided in a subsequent stage of the convolutional neural network, and learning is performed based on a difference between data to be output from the band pass filter and data acquired by applying the same type of band pass filter to data corresponding to learning data. Learning is performed based on output data acquired by emphasizing or removing an influence of a particular frequency by using the band pass filter.

According to one aspect of the present invention, a band pass filter is provided together with a converter in a previous stage of the convolutional neural network, and learning is performed by using data acquired by emphasizing or removing an influence of a particular frequency by the band pass filter before performing convolution.

According to one aspect of the present invention, various services are provided by a processing system that uses data acquired from a learned neural network by performing the processing described above. A device that provides the service by using the data is, for example, a television receiver that receives and displays television broadcasting, a display device that displays images, or an imaging device being a camera. Further, the device is an information processing device that includes a display unit and a communication unit and can transmit and receive information to/from the processing device or a computer, and may be, for example, a so-called smartphone, a game machine, or an audio device.

### Advantageous Effects of Invention

With the processing of the present invention, it is expected to improve the learning efficiency and the learning speed in a convolutional neural network.

### BRIEF DESCRIPTION OF DRAWINGS

FIG. 1 is a block diagram illustrating a configuration of an image processing device according to the present embodiment.

FIGS. 2A and 2B are functional block diagrams of the image processing device.

FIGS. 3A and 3B are explanatory diagrams illustrating a configuration of a CNN and a converter.

FIGS. 4A and 4B are functional block diagrams of an image processing device according to a first modification.

FIGS. 5A and 5B are explanatory diagrams illustrating a method of using a band pass filter.

FIG. 6 is a diagram illustrating one of content examples of the band pass filter.

FIG. 7 is a diagram illustrating another content example of the band pass filter.

FIG. 8 is a functional block diagram of an image processing device according to a second modification.

FIG. 9 is an explanatory diagram illustrating contents of a band pass filter.

### DESCRIPTION OF EMBODIMENTS

An arithmetic processing device according to the present application is described below with reference to drawings illustrating embodiments. In the present embodiment, an example in which processing in the arithmetic processing device is applied to an image processing device that performs processing with respect to an image is described.

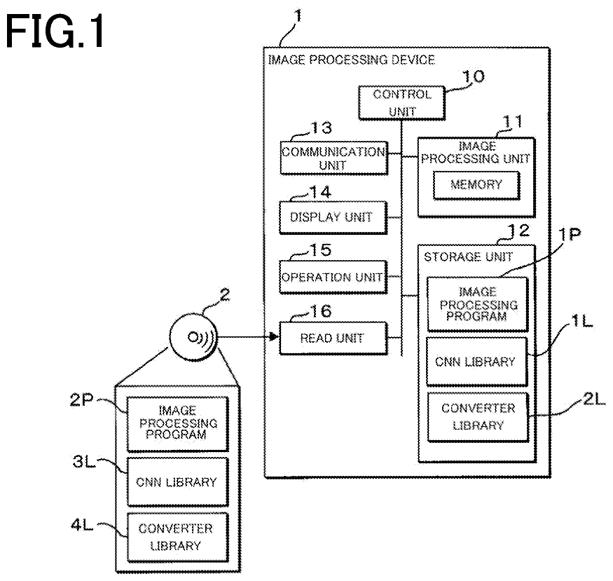

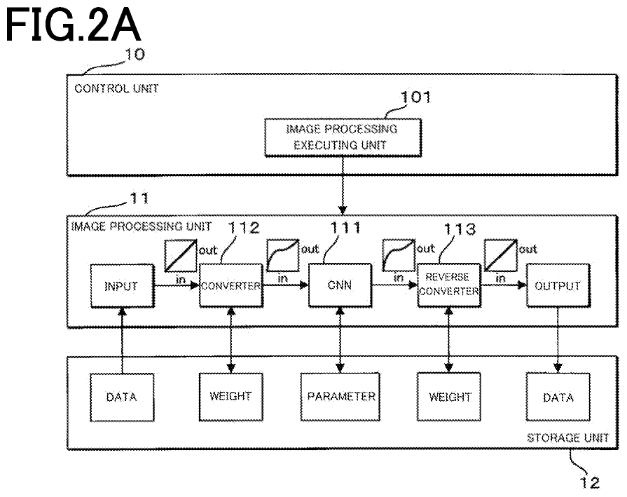

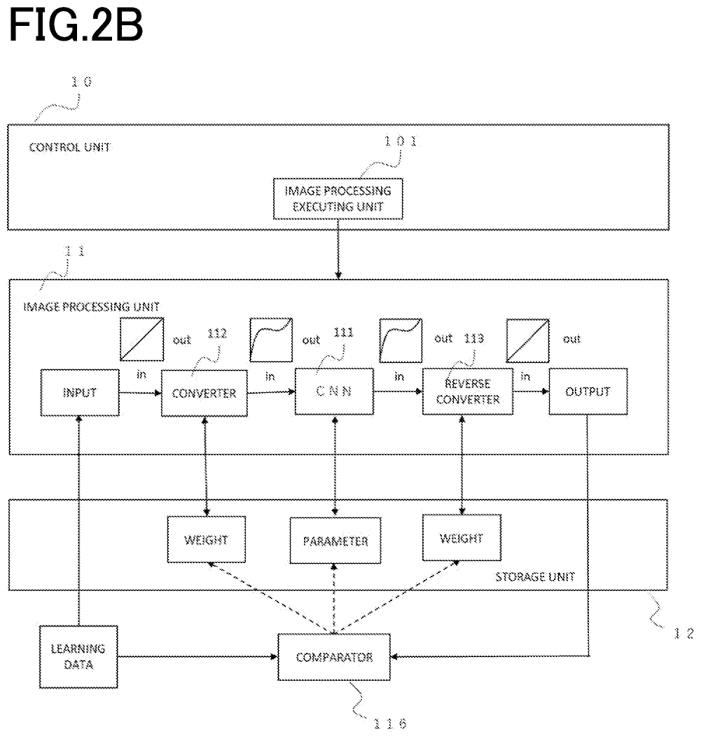

FIG. 1 is a block diagram illustrating a configuration of an image processing device 1 according to the present embodiment, and FIG. 2A is a functional block diagram of the image processing device 1 during processing, and FIG. 2B is a functional block diagram of the image processing device 1 during learning. The image processing device 1 includes a control unit 10, an image processing unit 11, a storage unit 12, a communication unit 13, a display unit 14, and an operation unit 15. The image processing device 1 and operations in the image processing device 1 are described below as one server computer. However, a configuration may be employed in which the image processing is performed by a plurality of computers in a distributed manner. The control unit 10 controls component parts of the device by using a processor such as a CPU (Central Processing Unit) and a memory to realize various functions. The image processing unit 11 performs image processing in response to a control instruction from the control unit 10 by using a processor such as a GPU (Graphics Processing Unit) or a dedicated circuit and a memory. The control unit 10 and the image processing unit 11 may be configured as one piece of hardware (SoC: System on a Chip) in which the processor such as a CPU or a GPU, a memory, and further, the storage unit 12 and the communication unit 13 are integrated.

As the storage unit 12, a hard disk or a flash memory is used. The storage unit 12 stores therein an image processing program 1P, a CNN library 1L that exerts a function for DL (Deep Learning), particularly as a CNN, and a converter library 2L. The storage unit 12 also stores therein information defining a CNN 111 created for each learning or a converter 112, parameter information including a weight coefficient in each layer in the learned CNN 111, or the like.

The communication unit 13 is a communication module that realizes communication connection to a communication network such as the Internet. The communication unit 13 uses a network card, a wireless communication device, or a carrier communication module.

The display unit 14 uses a liquid crystal panel, an organic EL (Electro Luminescence) display, or the like. The display unit 14 can display an image by the processing in the image processing unit 11 according to an instruction of the control unit 10.

The operation unit 15 includes a user interface such as a keyboard or a mouse. A physical button provided in a casing may be used. A software button to be displayed on the display unit 14 may be used. The operation unit 15 notifies the control unit 10 of information on user operations.

A read unit 16 can read an image processing program 2P, a CNN library 3L, and a converter library 4L stored in a recording medium 2 such as an optical disk, for example, by using a disk drive. The image processing program 1P, the CNN library 1L, and the converter library 2L stored in the storage unit 12 may be obtained by replicating the image processing program 2P, the CNN library 3L, and the converter library 4L read by the read unit 16 from the recording medium 2 by the control unit 10.

The control unit 10 of the image processing device 1 functions as an image processing executing unit 101 based on the image processing program 1P stored in the storage unit 12. Further, the image processing unit 11 functions as the CNN 111 (a CNN engine) by using a memory of the image processing unit 11 based on the CNN library 1L, definition data, and the parameter information stored in the storage unit 12, and also functions as a converter 112 by using the memory of the image processing unit 11 based on the converter library 2L and filter information. The image processing unit 11 may function as an inverse converter 113 according to the type of the converter 112.

The image processing executing unit 101 uses the CNN 111, the converter 112, and the inverse converter 113 to perform processes of providing data to each unit and acquiring data output from each unit. The image processing executing unit 101 inputs image data being input data to the converter 112 based on a user operation using the operation unit 15, and inputs data output from the converter 112 to the CNN 111. The image processing executing unit 101 also inputs data output from the CNN 111 to the inverse converter 113 according to need, and outputs data output from the inverse converter 113 to the storage unit 12 as output data. The image processing executing unit 101 may provide the output data to the image processing unit 11 to draw the data as an image and output the image to the display unit 14.

The CNN 111 includes a plurality of stages of convolutional layers and pooling layers defined by the definition data, and a fully connected layer, to extract a feature amount of input data and perform a classification based on the extracted feature amount.

The converter 112 includes convolutional layers and multi-channel layers as in the CNN 111, and performs non-linear conversion on the input data. Here, non-linear conversion refers to a process of non-linearly distorting an input value by, for example, color space conversion or level correction as illustrated in FIG. 2A. The inverse converter 113 includes convolutional layers and multi-channel layers and performs inverse conversion. The inverse converter 113 has the function of returning the distortion caused by the converter 112, but the returning the distortion is not limited to symmetric with the non-linear conversion by the converter 112.

When the image processing device 1 is trained, the learning data is input to the image processing unit 11 as shown in FIG. 2B, and the data processed by the image processing unit 11 and the learning data are compared by the comparator 116. Based on the comparison result, the parameters of the CNN 111 and the weighting coefficients of the converter 112 and the inverse converter 113 are adjusted. The learning data (second output data or fourth output data) and the output of the CNN 111 of the image processing unit 11 (first output data) or the output of the inverse converter 113 (third output data) can be input to the comparator 116.

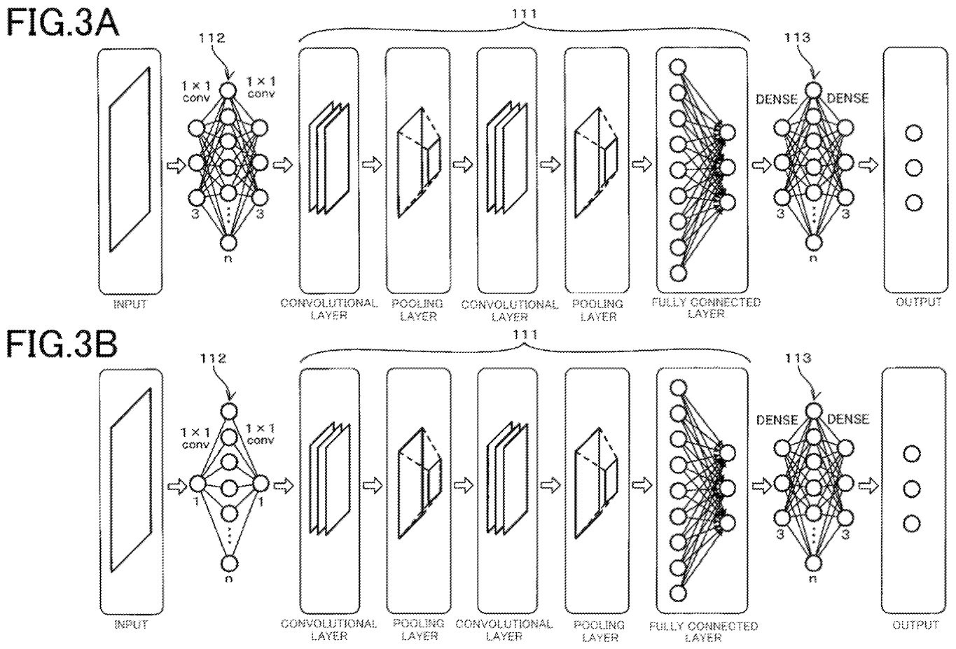

FIGS. 3A and 3B are explanatory diagrams illustrating a configuration of the CNN 111, the converter 112 and the inverse converter 113. In FIGS. 3A and 3B, the converter 112 and the inverse converter 113 are arranged an input and output of the CNN 111, respectively. As illustrated in FIGS. 3A and 3B, the converter 112 is configured by a first layer having the same number of channels as that of an input image, a second layer being a convolutional layer (CONV) having a larger number of nodes than that of the first layer, and a third layer having a fewer number of nodes than that of the second layer. In FIG. 3A, the number of channels is 3 (for example, an RGB color image), and in FIG. 3B, the number of channels is 1 (for example, a gray scale image). The second layer and the third layer are convolutional layers of a filter size of 1×1, having only one weight and bias. Accordingly, as illustrated in the functional block diagram in FIGS. 2A and 2B, a non-linear output can be acquired with respect to an input. The number of output channels (the number of nodes) in the third layer of the converter 112 is the same as the number of input channels in the example of FIGS. 3A and 3B. However, the number is not limited thereto, and may be decreased to be compressed, or may be increased (to be redundant). The converter 112 having such a configuration acts to distort a sample value of input data (in the case of image data, a pixel value (a luminance value)) non-linearly. Since the filter size of the convolutional layers are 1×1, non-linearly procedure does not depend on an adjacent sample.

The inverse converter 113 is configured by a first layer having the same number of channels (the number of nodes) as that of output channels of the CNN 111, a second layer being a dense layer (DENSE) having a larger number of nodes than that of the first layer, and a third layer having the same number of nodes (the number of output channels) as that of the first layer. In FIG. 3A and FIG. 3B, the number of input and output channels of the inverse converter 113 is 3. However, it suffices that the number of input and output channels is equal to the number of classifications. In the case of three classifications, there are three input nodes and three output nodes. In the case of ten classifications, there are ten input nodes and ten output nodes. The inverse converter 113 acts to distort an input sample value non-linearly, in the same manner as the converter 112, by performing non-linear conversion on an input. The inverse converter 113 is not limited to one having a dense layer in the second layer and may be configured by a convolutional layer instead of a dense layer.

The present embodiment has a configuration in which both the converter 112 and the inverse converter 113 are used. However, only the converter 112 or the inverse converter 113 may be used.

In the present embodiment, the image processing executing unit 101 performs learning of the converter 112 and the inverse converter 113 in the same way as CNN learning. Specifically, the image processing executing unit 101 performs a process of minimizing an error between output data acquired by inputting learning data to the CNN and a classification (an output) of known learning data to update a weight in the converter 112 or the inverse converter 113. A parameter in the CNN 111 acquired by the learning process and the weight in the converter 112 are stored in the storage unit 12 as corresponding parameters. When using the learned CNN 111, the image processing executing unit 101 uses the definition information defining the CNN 111, the parameters for the CNN stored in the storage unit 12, and the weight of the corresponding converter 112. The input data to the CNN 111 is acquired by inputting input data to the converter 112. In a case of using the inverse converter 113, the definition information for the learned CNN 111 acquired by learning, the parameter of the CNN 111, and the corresponding weight of the inverse converter 113 are used.

The converter 112 acts to emphasize a feature of an image to be extracted further by being applied in a previous stage of feature extraction by convolution. Accordingly, it is expected to improve the learning efficiency and learning accuracy in the CNN 111.

Among the hardware configurations of the image processing device 1 according to the present embodiment, the communication unit 13, the display unit 14, the operation unit 15, and the read unit 16 are not essential. The communication unit 13 is not used in some cases, after being used once, for example, at the time of acquiring the image processing program 1P, the CNN library 1L, and the converter library 2L stored in the storage unit 12 from an external server device. Similarly, there is a possibility that the read unit 16 is not used after the image processing program 1P, the CNN library 1L, and the converter library 2L are read and acquired. The communication unit 13 and the read unit 16 may be the same device using serial communication such as a USB (Universal Serial Bus).

The image processing device 1 may have a configuration as a Web server to provide only the functions as the CNN 111, the converter 112, and the inverse converter 113 described above to a Web client device including a display unit and a communication unit. In this case, the communication unit 13 is used to receive a request from the Web client device and transmit a processing result.

The function of the converter 112 in the present embodiment may be provided as a tool in pairs with the inverse converter 113, or either one. That is, a user can arbitrarily select a CNN connected to the converter 112 and/or the inverse converter 113. Learning of the selected CNN can be performed by using the converter 112 and/or the inverse converter 113 of the present embodiment.

In the present embodiment, a case in which image data configured by pixel values by color (RGB) arranged in a matrix is designated as input data, and learning is performed after performing conversion on the input data has been described as an example. However, the input data is not limited to image data, and any data having plural-dimensional information can be applied.

A function for calculating an error to be used at the time of learning, an appropriate function, such as a function for a square error, an absolute value error, or a cross entropy error, is preferably used according to data to be input and output and a learning object. For example, when an output is classification, the cross entropy error is preferable. The appropriate function is not limited to the error function, and flexible operation can be applied, for example, by using other standards. Evaluation may be performed by using an external CNN for the error function itself.

(First Modification)

Particularly when input data is set as image date in addition to usage of the converter 112 and the inverse converter 113 described in the present embodiment, it is expected to improve the learning efficiency and the learning accuracy further by using a band pass filter 114 for which an influence of a specific frequency component is taken into consideration.

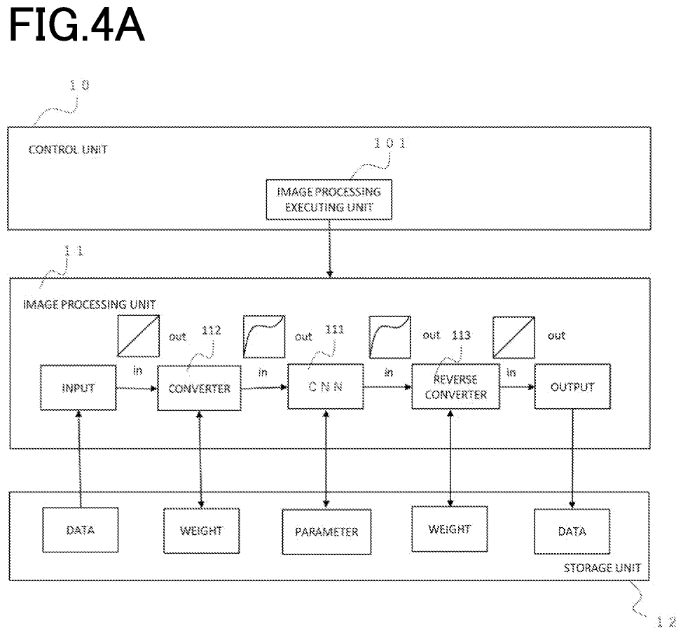

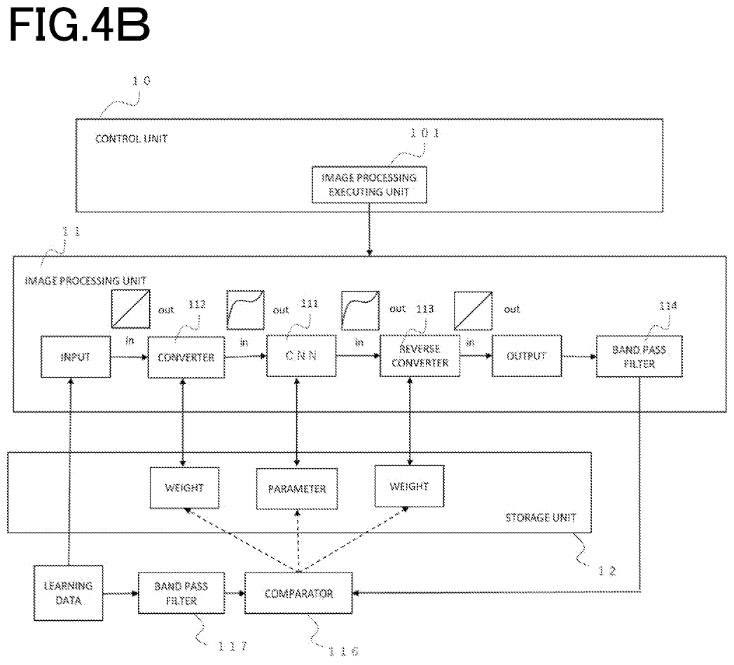

FIG. 4A is a functional block diagram of the image processing device 1 during processing, and FIG. 4B is a functional block diagram of the image processing device 1 during learning according to a first modification. As illustrated in FIG. 4B, the image processing unit 11 in the first modification includes the band pass filter 114 added in a subsequent stage of an output. The band pass filter 114 is a filter that removes or extracts a specific frequency. The band pass filter 114 is used only at the time of learning as shown in FIG. 4A. At the time of learning, the output of the band pass filter 114 is input to a comparator 116. An input data is also input to a band pass filter 117 and generated as training data, and the output of the band pass filter 117 is input to the comparator 116. The comparator 116 compares the output of the band pass filter 114 with the output of the band pass filter 117, and adjusts the weight function of the converter 112 and the inverse converter 113 and the definition parameters of the CNN 111. In the claims, the output data of CNN 111 means the first output data, the output data input from the band filter 114 to the comparator 116 means the fifth output data or the eleventh output data, and the learning data input to the band filter 117 means the second output data. The data input to the comparator 116 from the output of 117 means the sixth output data or the twelfth output data.

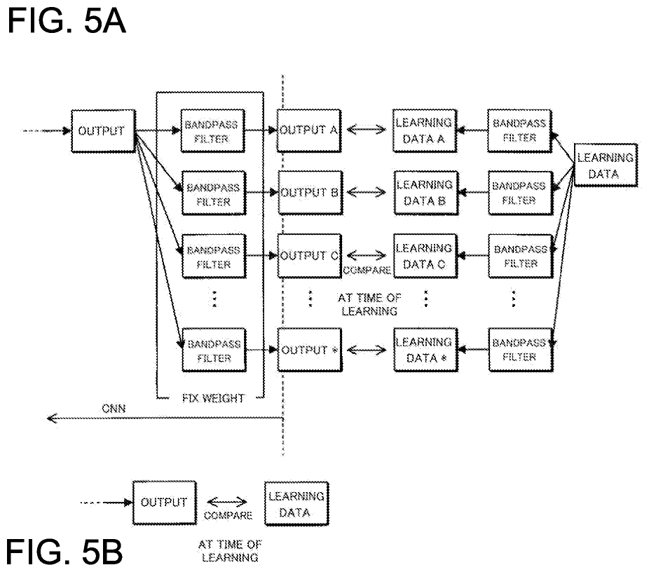

FIGS. 5A and 5B are explanatory diagrams illustrating a method of using the band pass filter 114. FIG. 5A illustrates a learning method using the band pass filter 114, and FIG. 5B illustrates a conventional learning method for facilitating explanations.

Conventionally, as illustrated in FIG. 5B, when learning using the CNN 111 is to be performed, output data acquired by inputting learning data to the CNN 111 is compared with known output data with respect to the learning data, to update a configuration of the convolutional layer and the pooling layer in the CNN 111 and parameters such as a weight coefficient so that an error is minimized. When a learning result is to be used, input data is provided to the learned CNN 111 using the updated configuration and parameter information to acquire output data.

In the first modification, a layer in which a weight is set so as to act as the band pass filter 114 is added to a subsequent stage of an output illustrated in FIG. 3A and FIG. 3B, to perform learning as a CNN on the whole including also an output from the band pass filter 114. Learning for the converter 112, the CNN 111, and inverse converter 113 is performed without changing the weight coefficient of the band pass filter 114. Specifically, the image processing executing unit 101 inputs learning data, designating the entirety including the converter 112, the CNN 111, the inverse converter 113, and a filter layer 114 sequentially as a CNN, to acquire output data from the band pass filter 114. The image processing executing unit 101 performs the same filtering process as the band pass filter 114 with respect to the learning data, and acquire reference data. The comparator 116 that is the one of the function of the image processing executing unit 101 compares output data after performing the filtering process with the learning data and the reference data, and update parameters such as weights of the converter 112, the CNN 111, the inverse converter 113 so that an error is minimized. It is desired to use a method in which learning is performed by multiplying each square error for each band by a coefficient so that the result is minimized. It is preferable to multiply the error between each output of the band filter (an output A, B, . . . ) and the learning data (a learning data A, B, . . . ) by a coefficient, and perform learning so that the squared error after the coefficient is multiplied is minimized. Here, the coefficient is determined by, for example, a priority assigned to each band. A timing to multiply the coefficient may be at the time of performing frequency decomposition by the band pass filter 114. When using the learned CNN 111, the image processing executing unit 101 acquires an output from the inverse converter 113 as a result, without using the band pass filter 114. Accordingly, learning taking into consideration a characteristic portion of the output data becomes possible, and improvement of the learning accuracy is expected. Further, the band pass filter 114 may be singly added without using the converter 112 and the inverse converter 113.

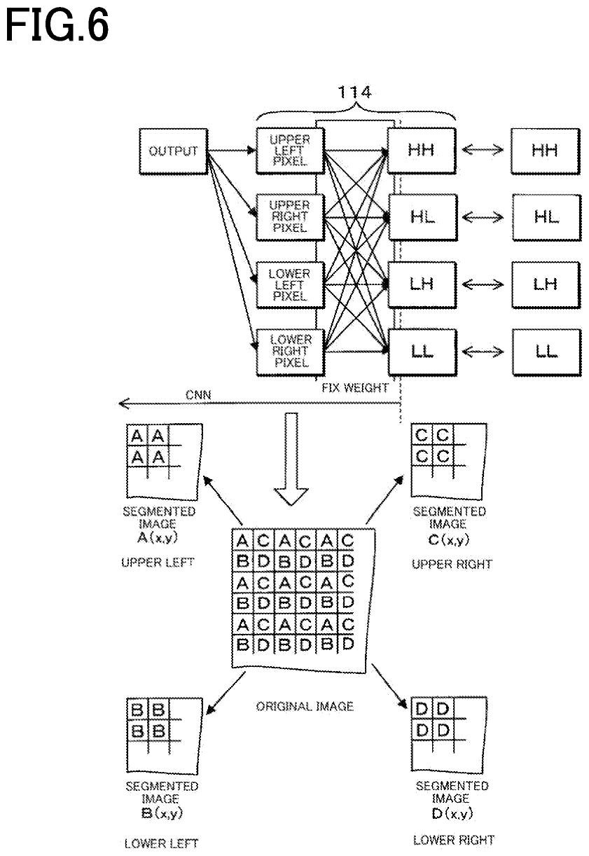

FIG. 6 is a diagram illustrating an example of the band pass filter 114. A function used in the band pass filter 114 is, for example, Haar transform (Haar wavelet transform). The band pass filter 114 is a filter having four nodes, each having a size of 2×2 and creating a segmented image (A) in which upper left pixels are consolidated, a segmented image (B) in which lower left pixels are consolidated, a segmented image (C) in which upper right pixels are consolidated, and a segmented image (D) in which lower right pixels are consolidated. The band pass filter 114 further converts the created segmented images to each sample of LL (a low frequency component), HL (a high frequency component in a vertical (y) direction), LH (a high frequency component in a horizontal (x) direction), and HH (a high frequency component). Specifically, input data (image data) is output by applying a filter as illustrated in the following expression (1).

$$\begin{matrix}[ Expression 1 ] & \\ ( \begin{matrix}{x}_{1 , 1} & {x}_{1 , 2} \\ {x}_{2 , 1} & {x}_{2.2}\end{matrix} ) \to ( \begin{matrix}\frac{1}{2} & \frac{1}{2} \\ \frac{1}{2} & - \frac{1}{2}\end{matrix} ) ( \begin{matrix}{x}_{1 , 1} & {x}_{1 , 2} \\ {x}_{2 , 1} & {x}_{2 , 2}\end{matrix} ) ( \begin{matrix}\frac{1}{2} & \frac{1}{2} \\ \frac{1}{2} & - \frac{1}{2}\end{matrix} ) = ( \begin{matrix}\frac{( {x}_{1 , 1} + {x}_{1 , 2} ) + ( {x}_{2 , 1} + {x}_{2 , 2} )}{4} & \frac{( {x}_{1 , 1} - {x}_{1 , 2} ) + ( {x}_{2 , 1} - {x}_{2 , 2} )}{4} \\ \frac{( {x}_{1 , 1} + {x}_{1 , 2} ) - ( {x}_{2 , 1} + {x}_{2 , 2} )}{4} & \frac{( {x}_{1 , 1} - {x}_{1 , 2} ) - ( {x}_{2 , 1} - {x}_{2 , 2} )}{4}\end{matrix} ) ≡ ( \begin{matrix}{y}_{1 , 1} & {y}_{1 , 2} \\ {y}_{2 , 1} & {y}_{2 , 2}\end{matrix} ) \\ Where , {x}_{1 , 1} \text{:} Upper left pixel , {x}_{1 , 2} \text{:} Upper right pixel , \\ {x}_{2 , 1} \text{:} Lower left pixel , {x}_{2 , 2} \text{:} Lower right peixel , \\ {y}_{1 , 1} \text{:} LL , {y}_{1 , 2} \text{:} HL , {y}_{2 , 1} \text{:} LH , {y}_{2 , 2} \text{:} HH & ( 1 )\end{matrix}$$

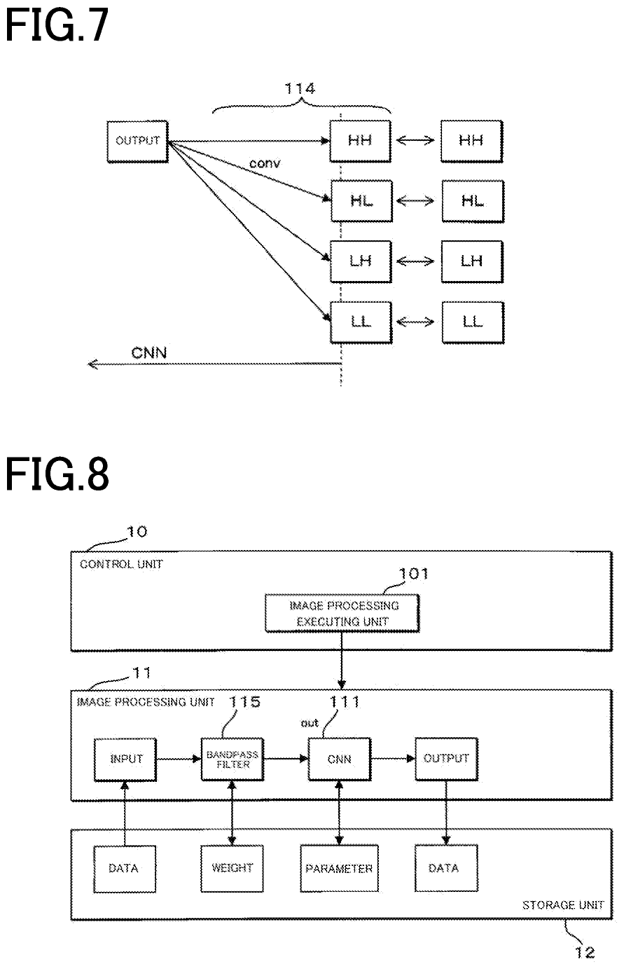

FIG. 7 is a diagram illustrating another example of the band pass filter 114. The band pass filter 114 performs, for example, as illustrated in FIG. 7, 5/3 discrete wavelet transform used in image compression in JPEG 2000. The LL sample may be further divided recursively into respective components of HH, HL, LH, and LL and used. As compared with Haar transform illustrated in FIG. 6, although an image is not divided into four pixels, a process executed by a filter illustrated in Expression 2 is substantially the same as the Haar transform illustrated in FIG. 6. When the image is divided into four pixels, a convolution coefficient becomes a 3×3 matrix.

$$\begin{matrix}[ Expression 2 ] & \\ HH = [ \begin{matrix}1 / 4 & - 1 / 2 & 1 / 4 \\ - 1 / 2 & 1 & - 1 / 2 \\ 1 / 4 & - 1 / 2 & 1 / 4\end{matrix} ] \\ LH = [ \begin{matrix}1 / 16 & - 1 / 8 & - 3 / 8 & - 1 / 8 & 1 / 16 \\ - 1 / 8 & 1 / 4 & 3 / 4 & 1 / 4 & - 1 / 8 \\ 1 / 16 & - 1 / 8 & - 3 / 8 & - 1 / 8 & 1 / 16\end{matrix} ] \\ HL = [ \begin{matrix}1 / 16 & - 1 / 8 & 1 / 16 \\ - 1 / 8 & 1 / 4 & - 1 / 8 \\ - 3 / 8 & 3 / 4 & - 3 / 8 \\ - 1 / 8 & 1 / 4 & - 1 / 8 \\ 1 / 16 & - 1 / 8 & 1 / 16\end{matrix} ] \\ LL = [ \begin{matrix}1 / 64 & - 1 / 32 & - 3 / 32 & - 1 / 32 & 1 / 64 \\ - 1 / 32 & 1 / 16 & 3 / 16 & 1 / 16 & - 1 / 32 \\ - 3 / 32 & 3 / 16 & 9 / 16 & 3 / 16 & - 3 / 32 \\ - 1 / 32 & 1 / 16 & 3 / 16 & 1 / 16 & - 1 / 32 \\ 1 / 64 & - 1 / 32 & - 3 / 32 & - 1 / 32 & 1 / 64\end{matrix} ] & ( 2 )\end{matrix}$$

In the case in which the band pass filter 114 having the contents illustrated in FIG. 7 is used, as illustrated in FIGS. 5A and 5B, the image processing executing unit 101 acquires learning data at the time of learning from outputs from the converter 112, the CNN 111, the inverse converter 113, and the band pass filter 114 provided in the subsequent stage thereof, and also acquires an output of a known classification result (image data) regarding the learning data similarly by using the band pass filter 114. The image processing executing unit 101 performs a process of updating the weights and parameters of the converter 112, the CNN 111, and the inverse converter 113 so that an error of a difference between these outputs is minimized. Here, as described by referring to FIG. 5A, it is preferable that a result obtained by multiplying the error of each output regarding each frequency (LL, HL, LH, HH) in FIG. 7 by a coefficient (a priority degree) is used to perform learning so that the error is minimized. When the learned CNN is to be used, the band pass filter 114 is not used.

The band pass filter 114 in the first modification may perform irreversible processing by adding a quantization process, while the band pass filter 114 is a reversible filter. A Gabor filter may be used.

The band pass filter 114 and the inverse converter 113 illustrated in the first modification may perform a process of rounding an output to 0 to 1 simply.

The band pass filter 114 in the subsequent stage of the output data illustrated in the first modifications can be applied to a previous stage of the converter 112.

(Second Modification)

FIG. 8 is a functional block diagram of the image processing device 1 according to the second modification. As illustrated in FIG. 8, the image processing unit 11 according to the second modification functions as a band pass filter 115 between an input and the CNN 111. The band pass filter 115 is a filter that removes or extracts a specific frequency. Accordingly, data in which a specific frequency is removed is input to the CNN 111, thereby enabling to expect improvement of the learning speed and the learning accuracy. In addition, the configuration may be such that the band pass filter 114 illustrated in the first modification is further provided in a subsequent stage of an output.

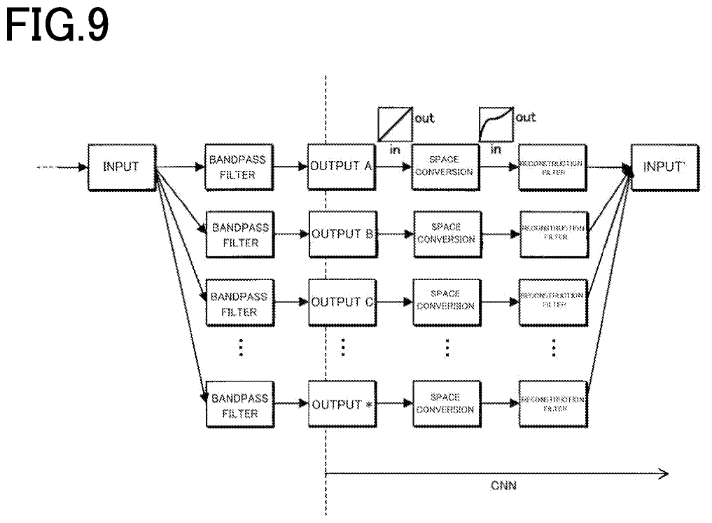

FIG. 9 is an explanatory diagram illustrating contents of the band pass filter 115. As illustrated in FIG. 9, the band pass filter 115 includes a first filter that performs wavelet transform or Gabor transform, an output layer (a memory) that holds an output of the first filter, a space conversion filter, and a reconstruction filter that reconstructs decomposed input data in a dimension same as the original dimension. The space conversion filter has the same configuration as the converter 112, which is a 1×1 convolutional layer having the number of input channels same as the number of channels in the output layer in the previous stage, and the number of nodes larger than the number of input channels. Accordingly, input data is output (decomposed) for each band by a fixed band pass filter. An output is filtered by performing deformation in the same manner as the converter 112, restored to the original form by the reconstruction filter, and input to the CNN. The reconstruction filter is not essential, and learning may be performed based on the decomposed input data.

The band pass filter 115 fixes the weight in the first filter and handles data after the space conversion filter as a CNN to perform learning. Specifically, the image processing executing unit 101 inputs learning data, designating the entirety including a part of the band pass filter 115 (the converter 112) and the CNN 111 sequentially as a CNN, to acquire output data. The image processing executing unit 101 compares the acquired output data with known output data of the learning data, to update parameters such as the weight of a part of the band pass filter 115 and the CNN 111, so that an error is minimized. The image processing executing unit 101 uses the band pass filter 115 as well, at the time of using the learned CNN 111. Accordingly, learning taking into consideration a characteristic portion of the output data becomes possible, and improvement of the learning accuracy is expected.

Particularly in the example of the second modification, it may be configured that image data is used as input data, and an image is obtained by rounding a frequency component in a portion of the band pass filter according to the image compression principle, or rounding is performed in a portion of space conversion. Accordingly, an image in which a specific frequency component is rounded is input to the CNN. In this case, it is expected that the accuracy image recognition will be improved according to the visual characteristics.

In the first and second modifications, the configuration is such that an error is calculated for an output divided by the band pass filter 114. However, the configuration is not limited thereto, and an error may be calculated together with an output that is not subjected to band division (FIG. 5B). Further, an error may be calculated (evaluated) together with an output obtained by using other standards different from the band division.

In the present embodiment and the first and second modifications, the present invention is realized by configuring the CNN as illustrated in FIGS. 3A and 3B. However, it is needless to say that the present invention may function as a part of a large-scale CNN including the configuration illustrated in FIGS. 3A and 3B.

The present embodiment as disclosed above is only an example in all respects and should not be construed as restrictive. The scope of the present invention is defined by the scope of claims and not by the contents described above, and it is intended that the scope of the present invention includes contents equivalent to the scope of claims and all the modifications within the scope.

### REFERENCE SIGNS LIST

1 image processing device
10 control unit
101 image processing executing unit
11 image processing unit
111 CNN
112 converter
113 inverse converter
1L CNN library
2L converter library

1. A processing device that inputs data to a convolutional neural network including a convolutional layer and acquires an output from the convolutional neural network, the processing device comprising a first converter that performs non-linear space conversion on data to be input to the convolutional neural network, and/or a second converter that performs non-linear space conversion on data to be output from the convolutional neural network, wherein the first converter or the second converter stores therein a parameter learned together with the convolutional neural network.

2. The processing device according to claim 1, wherein the first and second converters include an input layer having number of nodes same as number of channels of the data to be input to the convolutional neural network or number of output channels, a second layer being a convolutional layer or a dense layer having a larger number of nodes than the input layer, and a third layer being a convolutional layer or a dense layer having a smaller number of nodes than the second layer.

3. The processing device according to claim 2, wherein the first converter stores therein a parameter in the first converter learned based on a difference between first output data to be acquired by inputting data acquired by converting learning data by the first converter to the convolutional neural network, and second output data corresponding to the learning data.

4. The processing device according to claim 2, wherein the second converter stores therein a parameter in the second converter learned based on a difference between third output data acquired by converting data acquired by converting learning data by the first converter, or output data acquired by inputting the learning data to the convolutional neural network without performing conversion by the first converter, by the second converter, and fourth output data corresponding to the learning data.

5. The processing device according to claim 1, comprising:
a band pass filter that decomposes data to be output from the convolutional neural network according to a frequency; and
a learning executing unit that learns parameters in the first converter and the convolutional neural network based on a difference between fifth output data acquired by inputting first output data, which is acquired by converting learning data by the first converter and inputting the converted data to the convolutional neural network, to the band pass filter, and sixth output data acquired by inputting second output data corresponding to the learning data to the band pass filter.

6. The processing device according to claim 1, comprising:
a band pass filter that decomposes data output from the convolutional neural network according to a frequency; and
a learning executing unit that learns a parameter in the convolutional neural network based on a difference between eleventh output data acquired by inputting output data, which is acquired by inputting learning data to the convolutional neural network, to the band pass filter, and twelfth output data acquired by inputting second output data corresponding to the learning data to the band pass filter.

7. (canceled)

8. The processing device according to claim 1, wherein the data is image data configured by values of pixels arranged in a matrix.

9-12. (canceled)

13. A processing method of inputting data to a convolutional neural network including a convolutional layer and acquiring an output from the convolutional neural network, wherein non-linear space conversion is performed on data to be input to the convolutional neural network by using a converter that stores therein a parameter learned together with the convolutional neural network, and space-converted data is input to the convolutional neural network.

14. The processing method according to claim 13, wherein the space conversion is performed by using a space conversion parameter learned based on a difference between first output data acquired by inputting data obtained by performing the space conversion on learning data to the convolutional neural network, and second output data corresponding to the learning data.

15-16. (canceled)

17. A computer program that causes a computer to execute:
a process of receiving data to be input to a convolutional neural network including a convolutional layer;
a process of performing non-linear space conversion on the data; and
a process of learning parameters in space conversion and the convolutional neural network based on a difference between first output data acquired by inputting data obtained by performing space conversion on learning data to the convolutional neural network, and second output data corresponding to the learning data.

18-20. (canceled)
